(19) United States
(12) Patent Application Publication
(10) Pub. No.: US 2009/0162273 A1
(43) Pub. Date: Jun. 25, 2009

(54) Chromium oxide powder having a reduced level of hexavalent chromium and a method of making the powder

(75) Inventors: Daniel E. Lawrynowicz, Cornwall, NY (US); Haitong Zeng, Oakland, NJ (US); Zongtao Zhang, Unionville, CT (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Howmedica Osteonics Corp., Mahwah, NJ (US)

(21) Appl. No.: 12/004,769

(22) Filed: Dec. 21, 2007

(51) Int. Cl. C01G 37/02

(52) U.S. Cl. 423/607

(57) ABSTRACT

A refined chromium oxide powder having a reduced level of hexavalent chromium. The refined powder may be produced by acid and reduction washing or by heat treatment to reduce the hexavalent chromium to a biocompatible level. The powder is then packaged to limit oxidation and absorption of moisture.

### BACKGROUND OF THE INVENTION

The present invention relates to a chromium oxide (Cr₂O₃) powder having a reduced level of hexavalent chromium suitable for use in a thermal spray to produce a biocompatible coating on a medical implant. The invention also relates to a method of reducing the level of hexavalent chromium in preparing this powder.

Medical implant components may be used within a patient for replacement surgery such as hip replacement surgery or the like. Such medical implant components may include femoral head components and acetabular cup components. With such components, a ball or mating portion of the femoral head component is adapted to mate with a mating portion of the acetabular cup component.

After a medical implant component is surgically implanted in a patient, a mating portion thereof (such as the ball portion of a femoral head component) will move many times within a mating portion of another medical implant component (such as that of the acetabular cup component) or, if a single medical implant component is used and affixed to a bone or the like of a patient, within or relative to such portion of the patient.

As is to be appreciated, the medical implant component or components should provide excellent wear capability so as to survive for a relatively long period of time. In an attempt to provide for such wear capability, one or both of the components may be coated with a predetermined material or materials. For example, the ball portion of the femoral head component may be coated with a predetermined coating material. Such coating may be applied by a thermal spray process, chemical vapor deposition (CVD) or physical vapor deposition (PVD). These coating processes may enable only a relatively thin coating to be applied.

The use of a relatively thin coating on a mating or bearing surface of a medical implant component may result in a failure of the coating during use. As an example, consider the situation if a foreign material were to get into the joint between the ball portion of a femoral head component and the mating or bearing portion of an acetabular cup component. During movement, the foreign material may rub against the coating on the ball portion. As a result, a scratch or crack in the coating may develop which may spread. Additionally, other scratches or cracks may also develop and grow into larger cracks. Eventually, such crack or cracks may result in particles of the coating material being removed from or flaking off from the implant component. As is to be appreciated, such particles or flakes of the coating material inside a patient are not desirable. As a result, the wear life of the medical implant component or components may be adversely affected and components may need to be replaced. Accordingly, it is preferable for the coatings on medical implant components to be produced using relatively hard and durable materials. As an example, such coatings may be formed from a biocompatible material such as a cobalt chromium alloy having a carbide content.

Another material which provides preferable performance characteristics is chromium oxide (chromia, Cr₂O₃). Chromium oxide provides excellent wear properties including low wear, no corrosion, strong bonding, and does not crack. However, chromium oxide coatings typically also contain hexavalent chromium (Cr6+, Cr(VI)). Hexavalent chromium is a known carcinogen and is therefore not biocompatible above specified levels. Accordingly, chromium oxide has heretofore not been used as a coating on medical implant components. Rather, to take advantage of chromium's wear properties, coatings are often produced using composite materials of chromium combined with other materials (such as Titanium, Silicon, and Cobalt). These other materials chemically combine with the chromium in such a manner that hexavalent chromium is significantly reduced. However, these composite coatings also have inferior wear properties to a pure chromium oxide coating. Accordingly, it would be advantageous to produce a biocompatible chromium oxide coating on a medical implant.

Because of the presence of hexavalent chromium, chromium oxide is currently not used by medical device manufacturers. However, chromium oxide is often used in other (non-medical) applications. For these non-medical applications, the chromium oxide is typically purchased as a powdered feedstock which is thermally sprayed to produce a coating layer on a component. These chromium oxide powders often have hexavalent chromium levels in the range of 10-500 ppm (parts-per-million). While such levels of hexavalent chrome are acceptable for non-medical applications, the toxicity and cancer risk is too high for use in medical devices. Further, hexavalent chromium in the chromium oxide powder also poses a potential safety hazard to thermal spray operators handling the feedstock. Accordingly, it would be advantageous to produce a chromium oxide powder with a reduced level of hexavalent chromium (preferably to a biocompatible level) to improve safety for those handling the feedstock.

In addition, chromium oxide powder readily absorbs moisture when exposed to air. This absorption results in agglomeration of the powder into larger particles (also referred to as chunks). These larger particles can clog the feeder of a thermal sprayer. The chromium oxide powder may also chemically react when exposed to oxygen and water. Such reactions may result in increased levels of hexavalent chromium in the chromium oxide. Accordingly, it would be advantageous to package the chromium oxide powder to prevent agglomeration and stabilize the powder.

### SUMMARY OF THE INVENTION

The present invention is directed to a chromium oxide powder (Cr₂O₃) having a reduced level of hexavalent chromium to a biocompatible level so that a chromium oxide coating can be used on an implant. The invention also provides methods for reducing the hexavalent chromium in the feedstock powder to increase safety for the thermal spray operator. The present invention also includes a method of packaging the chromium oxide powder to prevent agglomeration and stabilize the powder.

A first embodiment of the present invention is a method of producing a refined chromium oxide feedstock having a reduced level of hexavalent chromium. The method includes acid and reduction washing a chromium oxide powder to reduce the hexavalent chromium to the reduced level, thereby producing the refined chromium oxide feedstock. The refined chromium oxide feedstock is packaged to limit oxidation and absorption of moisture. The method may also encompass the steps of spray-drying a raw chromium oxide feedstock, fusing the spray-dried feedstock, crushing the fused feedstock into the chromium oxide powder, and classifying the chromium oxide powder by particulate size.

Other aspects of this first embodiment may include that the reduced level may be less than a biocompatible threshold level. The reduced level may be less than 2 ppm (two parts-per-million) of hexavalent chromium. The fusing process may alternatively be a sintering process. The packaging step may involve hermetically sealing the refined chromium oxide feedstock under vacuum or with an inert gas. The acid and reduction washing step may include mixing the chromium oxide powder with sulfuric acid to create an acidic environment, water to dissolve the hexavalent chromium into chromic acid, and oxalic acid to reduce the chromic acid into trivalent chromium, whereby the trivalent chromium may be in the form of a water soluble compound removable by washing. The refined chromium oxide feedstock may be suitable for use in thermal spraying a coating on an implant.

A second embodiment of the present invention is a method of producing a refined chromium oxide feedstock having a reduced level of hexavalent chromium. The method includes heat treating a chromium oxide powder to reduce the hexavalent chromium to the reduced level, thereby producing the refined chromium oxide feedstock. The refined chromium oxide feedstock is packaged to limit oxidation and absorption of moisture. The method may also encompass the steps of spray-drying a raw chromium oxide feedstock, fusing the spray-dried feedstock, crushing the fused feedstock into the chromium oxide powder, and classifying the chromium oxide powder by particulate size.

Other aspects of this second embodiment may include that the reduced level may be less than a biocompatible threshold level. The reduced level may be less than 2 ppm (two parts-per-million) of hexavalent chromium. The fusing process may alternatively be a sintering process. The packaging step may involve hermetically sealing the refined chromium oxide feedstock under vacuum or with an inert gas. The heat treatment step may include heating the chromium oxide powder at a predetermined temperature for a predetermined time under vacuum or with an inert gas to convert the hexavalent chromium into trivalent chromium. The predetermined temperature may be at least 250 degrees Celsius and the predetermined time may be at least 2 hours. The refined chromium oxide feedstock may be suitable for use in thermal spraying a coating on an implant.

The present invention also encompasses the refined chromium oxide feedstock having the reduced level of hexavalent chromium which is produced by the above processing steps.

A more complete appreciation of the subject matter of the present invention and the various advantages thereof can be realized by reference to the following detailed description in which reference is made to the accompanying drawings wherein like reference numbers or characters refer to similar elements.

### BRIEF DESCRIPTION OF THE DRAWINGS

FIG. 1 is a flowchart of the prior art processing steps used in refining chromium oxide feedstock in preparation for thermal spraying;

FIG. 2 is a flowchart of the processing steps according to the first embodiment of the present invention for refining chromium oxide feedstock having reduced hexavalent chromium content in preparation for thermal spraying; and

FIG. 3 is a flowchart of the processing steps according to the second embodiment of the present invention for refining chromium oxide feedstock having reduced hexavalent chromium content in preparation for thermal spraying.

### DETAILED DESCRIPTION

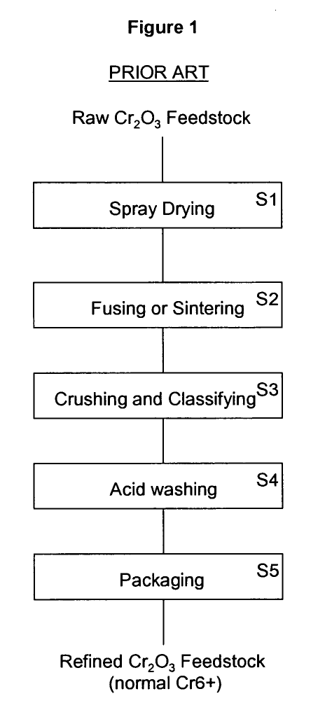

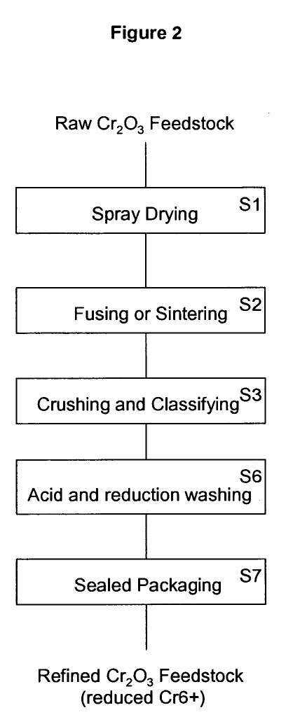

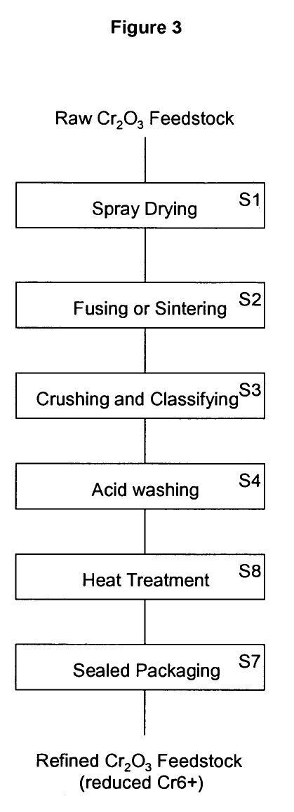

As discussed above, the invention is directed to methods of producing a refined chromium oxide powder having a reduced level of hexavalent chromium suitable for use in forming a chromium coating by thermal spraying. The methods will be discussed by comparing the steps performed in the prior art (FIG. 1) with the steps according to the first and second embodiments of the present invention (FIGS. 2 and 3).

Both the present method and the prior art method start with raw chromium oxide feedstock. Typically, this raw feedstock is a very fine powder sold in drums or barrels. The raw feedstock invariably contains hexavalent chromium compounds (often around 100 ppm) and various undesirable impurities. The soluble hexavalent chromium is most commonly in the form of chromic acid (H₂CrO₄, H₂Cr₂O₇) and chromic acid anhydride (CrO₃). The first processing step for the raw material is usually spray drying S1 to agglomerate fine particles into larger and flowable feedstock. Spray drying is a commonly used method of drying a liquid stream through a hot gas. The fine powder is mixed with water and a binder to form a slurry. The spray dryer sprays the slurry through a nozzle into a hot vapor stream which produces fine droplets. Droplet sizes can range from 20 μm to 180 μm depending on the nozzle. As moisture quickly leaves the droplets, the chromium oxide is separated out as a dried powder.

The dried powder is then formed into a large block by a fusing or sintering process (step S2). In this process, a graphite crucible under a flow of hydrogen (H₂) gas (or any other suitable gas) may be filled with the dried chromium oxide powder and heated below its melting point (e.g. to between 1550-1600° C.) until its particles adhere to one another and form a chromium oxide block. As a byproduct of this process, the heat may produce a shiny metal covering of chromium (Cr) metal to form on the chromium oxide block.

The chromium oxide block is then mechanically crushed into powder having a desired particle size distribution (step S3). Particle size and the size distribution are important to maintain a steady flow during use of the powder in a thermal spray. The crushed powder can be classified either by processing through a series of varying sized mesh sieves or through an air classification system to ascertain its particle size distribution. The crushed powder is typically comprised of particles ranging between 5-65 um and preferably between 10-45 um. An exemplary particle size distribution is 10% pass at 13-15 um, 50% pass at 19-21 um, 90% pass at about 35 um, 95% pass at about 45 um, and 100% pass at about 65 um. Note, the crushing process also crushes the Cr metal on the surface of the block into the powder.

The hexavalent chromium content of the powder can vary dramatically in the crushing process. This may simply be due to variations in room temperature and humidity during the crushing process. Obviously, such ambient conditions can change daily if not controlled. One possible way to control this variation is to perform the crushing in an inert gas (or any other suitable gas) environment.

The crushed and classified chromium oxide powder is then acid washed to remove additional impurities such as the Cr metal formed on the surface of the block during the sintering/fusing step (step S4). Sulfuric acid (H₂SO₄) is added to the powder to react with the Cr metal to form chromium sulfate (Cr₂(SO₄)₃) as shown in reaction (1).

2Cr+3H₂SO₄═Cr₂(SO₄)₃+3H₂ (1)

The chromium sulfate is water soluble and can simply be washed away. The remaining chromium oxide powder is then (air) dried. The resulting powder is a refined chromium oxide feedstock which can be used for thermal spraying. Currently available commercial pure feedstock (>99.6% Cr₂O₃, particle size 10-45 um) may contain between 9 ppm and 485 ppm of hexavalent chromium. Please note the above process is simply provided as an example and other acid washing processes may be used.

Some of the hexavalent chromium in the refined chromium oxide feedstock is produced by oxidation due to dissolved oxygen in the water used for washing. During the washing process, oxygen can convert some trivalent chromium ions (in the chromium sulfate) into hexavalent chromium ions (in the chromic acid, H₂CrO₄) as described in reaction (2).

Cr₂(SO₄)₃+O₂+2H₂O=2H₂CrO₄+3SO₂+O₂ (2)

Additional hexavalent chromium may be produced in the drying process.

The refined chromium oxide feedstock is then packaged for commercial sale. The powder may be packed into bottles or other suitable containers for shipment and storage. The packing may not be air-tight and typically is performed under ambient factory conditions. This allows the chromium oxide (Cr₂O₃) to absorb moisture (water, H₂O) and oxygen (02) resulting in the formation of a small additional amount of hexavalent chromium compound (e.g. H₂CrO4) on the surface of the powder. This reaction, which is similar to oxidizing reaction (2) as described above, is possible because the washing process cannot completely remove all the trivalent chromium ions (Cr³⁺) from the powder. In addition, the absorption of water can bind the particles together (i.e. to form clumps/chunks) which impair the flow of powder into a thermal sprayer.

The first embodiment of the present invention combines the prior art acid washing step S4 with a reduction process (step S6). In this acid and reduction washing step S6, both metallic chromium (Cr) and hexavalent chromium are removed from the crushed and classified chromium oxide powder. Hexavalent chromium is a strong oxidizing agent, which can be reduced by a reducing agent in acidic solution (pH<7). An example of a suitable acid and reduction reaction is:

Cr₂O₃+2H₂CrO₄+H₂C₂O₄+3H₂SO₄═Cr₂O₃+Cr₂(SO₄)₃+2CO₂+8H₂ (3)

where the chromium oxide (Cr₂O₃) powder is added to a mixture of water (H₂O), oxalic acid (H₂C₂O₄), and sulfuric acid (H₂SO₄). The sulfuric acid provides the acidic environment for the reaction to occur. Hexavalent chromium (Cr6+) in the chromium oxide (Cr₂O₃) reacts with the water to form chromic acid (H₂CrO₄). The chromic acid is reduced by the oxalic acid into trivalent chromium (Cr3+). The trivalent chromium reacts with the sulfuric acid to form chromium sulfate (Cr₂(SO₄)₃). The chromium sulfate is water soluble and non-toxic. The chromium sulfate is simply washed away with water. The carbon dioxide (CO₂) gas simply bubbles out of the solution. By keeping the concentration of the reducing agent (e.g. oxalic acid) far higher than any dissolved oxidizing agents (e.g. O₂), the reaction (3) is kept in a reducing condition such that any hexavalent chromium is reduced to trivalent chromium. This reaction reduces the hexavalent chromium present in the chromium oxide powder to a significantly reduced level. Experimental results indicate the reduced level of hexavalent chromium may be less than seven parts per million (7 ppm) and preferably less than 2 ppm. Ideally, the hexavalent chromium is reduced to a biocompatible level suitable for use on implants. Regardless, the reduced level is safer for thermal spray operators that handle the powder. The reacted chromium oxide is then dried back into a refined feedstock powder for packaging.

The acid reduction process is economical and easy to perform by simply adding a small amount of reducing agent; such as 1-5%/wt Oxalic acid (H₂C₂O₄) into the acid washing solution used in step S4. Note that other reducing and water soluble compounds may be used in this step to remove the hexavalent chromium. For example, compounds containing Ni2+, Fe2+, Zn2+, Sn2+, etc. . . . ions, and sulfite acids (H₂SO₃, NaHSO₃) may alternatively be used. Oxalic acid and sulfite acids are preferred because they does not introduce other metallic impurities into the washing process.

The second embodiment of the present invention follows the prior art acid washing step S4 with a heat treatment process (step S8). This heat treatment can also be used as a post-treatment of refined chromium oxide powder (containing hexavalent chromium) processed using the prior art technique shown in FIG. 1. The hexavalent chromium compounds in the chromium oxide powder are primarily CrO₃ and H₂CrO₄. Much of the hexavalent chromium can be removed by the application of heat (>196° C.) under an inert gas or vacuum to decompose and evaporate the hexavalent chromium compounds. The chemical reactions involved in such a heat treatment are:

CrO₃(s)=CrO₃(g) (3)

2CrO₃(s)=Cr₂O₃+3/2O₂(g) (4)

2H₂CrO₄(s)=Cr₂O₃(s)+2H₂O(g)+1/2O₂ (5)

where s and g indicate solid and gaseous forms respectively. The solid forms of CrO₃ and H₂CrO₄ are stable at room temperature, but not at higher temperatures (>196° C.). For example, CrO₃ has a boiling point of 196° C. When heat (>196° C.) is applied, the chemical equilibrium of the reaction equations (3-5) shifts to the right. The heat treatment is preferably performed under an inert gas (such as N₂ or Ar) or in a vacuum. During treatment, the hexavalent chromium compounds transform into non-toxic Cr₂O₃, O₂ and H₂O. As this is a solid-gas reaction, the temperature, time, powder loading and mass transfer each influence the speed of the reactions. For example, small quantities of powder (<100 gm) can be processed at a relatively low temperature (<500° C.) for a relatively short time period (<2 hr) in a fixed bed furnace. Whereas, larger quantities (>1 kg) may be processed using a fixed bed furnace for a relatively long time period (>4 hr) at a relatively high temperature (>900° C.). Even larger quantities (>10 kg) are preferably processed using a fluidizing bed in a rotary furnace. Such heat treatment reduces the hexavalent chromium present in the chromium oxide powder to a significantly reduced level. Experimental results indicate the reduced level of hexavalent chromium may be less than two parts per million (2 ppm). Ideally, the hexavalent chromium is reduced to a biocompatible level suitable for use on implants. Regardless, the reduced level is safer for thermal spray operators that handle the powder.

Both the first and second embodiments of the present invention replace the prior art packaging step S5 with a sealed packaging step S7. This packaging step is important to maintain the reduced level of hexavalent chromium in the refined chromium oxide powder during shipment and storage. As mentioned above, the prior art drying and packing processes are conducted in air. Such packing exposes the powder to oxygen and water. The chromium oxide powder can react with oxygen and water to produce additional hexavalent chromium compounds. To prevent this exposure, the present invention packs the chromium oxide powder in air-tight, sealed containers (e.g. bottles). The sealed packing is conducted in an inert gas (such as N₂ or Ar) or vacuum environment. In this way, the powder is protected from exposure to the air and the reduced level of hexavalent chromium can be maintained. This step also prevents the powder from absorbing moisture which degrades its consistency by the formation of chunks. These chunks can adversely impact the quality of the coating formed by the powder. Such packing is also economical and convenient. This sealed packaging step S7 may be alternatively referred to and/or include anaerobic packaging, vacuum packing, hermetic sealing, and/or inert gas packaging.

The present invention is also applicable to composite powders of chromium oxide (in addition to pure Cr₂O₃ (>99.0%)). Such composites may include Cr₂O₃—Al₂O₃ (1-99% Al₂O₃), Cr₂O₃—TiO₂ (1-99% TiO₂), Cr₂O₃—TiO₂—SiO₂ (>1% Cr₂O₃). However, the present invention is not limited to these composites and any other suitable composite may be used.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of producing a refined chromium oxide powder having a reduced level of hexavalent chromium, comprising the steps of:
acid and reduction washing a chromium oxide powder having a first level of hexavalent chromium to reduce the hexavalent chromium to said reduced level, thereby producing the refined chromium oxide powder; and
packaging the refined chromium oxide powder to limit oxidation and absorption of moisture.

2. The method according to claim 1, further comprising the steps of:
spray-drying a raw chromium oxide feedstock;
fusing the spray-dried feedstock; and
crushing the fused feedstock into the chromium oxide powder.

3. The method according to claim 2, wherein the crushing step includes classifying the chromium oxide powder by particulate size

4. The method according to claim 1, wherein the reduced level is less than a biocompatible threshold level.

5. The method according to claim 1, wherein the reduced level is less than 2 ppm (two parts-per-million) of hexavalent chromium.

6. The method according to claim 1, wherein the fusing step is alternatively a sintering process.

7. The method according to claim 1, wherein the packaging step involves hermetically sealing the refined chromium oxide powder under vacuum or with an inert gas.

8. The method according to claim 1, wherein the acid and reduction washing step comprises mixing the chromium oxide powder with an acid to create an acidic environment, water to dissolve the hexavalent chromium into chromic acid, and oxalic acid or sulfite acid to reduce the chromic acid into trivalent chromium,
whereby the trivalent chromium forms a water soluble compound removed by washing.

9. The method according to claim 1, wherein the refined chromium oxide powder is suitable for use in thermal spraying a coating on an implant.

10. A refined chromium oxide powder having a reduced level of hexavalent chromium, produced by the process steps of:
spray-drying a raw chromium oxide feedstock;
fusing the spray-dried feedstock;
crushing the fused feedstock into a chromium oxide powder having a first level of hexavalent chromium and classifying the chromium oxide powder by particulate size;
acid and reduction washing the chromium oxide powder to reduce the hexavalent chromium to said reduced level, thereby producing the refined chromium oxide powder; and
packaging the refined chromium oxide powder to limit oxidation and absorption of moisture.

11. A method of producing a refined chromium oxide powder having a reduced level of hexavalent chromium, comprising the steps of:
heat treating a chromium oxide powder having a first level of hexavalent chromium to reduce the hexavalent chromium to said reduced level, thereby producing the refined chromium oxide powder; and
packaging the refined chromium oxide powder to limit oxidation and absorption of moisture.

12. The method according to claim 11, further comprising the steps of:
spray-drying a raw chromium oxide feedstock;
fusing the spray-dried feedstock; and
crushing the fused feedstock into the chromium oxide powder.

13. The method according to claim 12, wherein the crushing step includes classifying the chromium oxide powder by particulate size

14. The method according to claim 11, wherein the reduced level is less than a biocompatible threshold level.

15. The method according to claim 11, wherein the reduced level is less than 2 ppm (two parts-per-million) of hexavalent chromium.

16. The method according to claim 11, wherein the fusing step is alternatively a sintering process.

17. The method according to claim 11, wherein the packaging step involves hermetically sealing the refined chromium oxide powder under vacuum or with an inert gas.

18. The method according to claim 11, wherein the heat treatment step comprises heating the chromium oxide powder at a predetermined temperature for a predetermined time under vacuum or with an inert gas to convert the hexavalent chromium into trivalent chromium.

19. The method according to claim 18, wherein the predetermined temperature is at least 196 degrees Celsius and the predetermined time is at least 2 hours.

20. The method according to claim 19, wherein the predetermined temperature is at least 950 degrees Celsius.

21. The method according to claim 11, wherein the refined chromium oxide powder is suitable for use in thermal spraying a coating on an implant.

22. A refined chromium oxide powder having a reduced level of hexavalent chromium, produced by the process steps of:
heat treating a chromium oxide powder having a first level of hexavalent chromium to reduce the hexavalent chromium to said reduced level, thereby producing the refined chromium oxide powder; and
packaging the refined chromium oxide powder to limit oxidation and absorption of moisture.

23. A refined chromium oxide powder having less than 7 ppm (seven parts-per-million) of hexavalent chromium, the refined powder being suitable for use in thermal spraying a coating on a medical implant.

24. The refined chromium oxide powder according to claim 23, having less than 2 ppm of hexavalent chromium.

25. A composite chromium oxide powder including a chromium oxide component having less than 7 ppm (seven parts-per-million) of hexavalent chromium, the composite powder being suitable for use in thermal spraying a coating on a medical implant.
